(19) United States
(12) Patent Application Publication
(10) Pub. No.: US 2026/0093776 A1
(43) Pub. Date: Apr. 2, 2026

(54) SYSTEM AND METHOD FOR LOADING COEFFICIENT MATRICES IN A DIAGONALIZED PATTERN

(71) Applicant: UNTETHER AI CORPORATION, Toronto (CA)

(72) Inventors: William Martin Snelgrove, Toronto (CA); John S. Kitamura, Toronto (CA)

(21) Appl. No.: 18/903,458

(22) Filed: Oct. 1, 2024

(51) Int. Cl. G06F 17/16

(52) U.S. Cl. CPC G06F 17/16

(57) ABSTRACT

An example device includes a plurality of processing elements configured to perform a processing operation; memory cells interconnected with the processing elements, the memory cells organized into a plurality of wordlines, each wordline containing a set of columns; a controller interconnected with the processing elements, the controller configured to: for each coefficient vector of a coefficient matrix for the processing operation: assign a wordline identifier to each processing element; assign a column identifier to each processing element; write coefficients from the coefficient vector to the corresponding memory cell defined by the wordline identifier and the column identifier for each processing element; wherein the wordline identifiers and the column identifiers are assigned to the processing elements to load the coefficients of the coefficient vector in a diagonalized pattern in the memory cells.

### FIELD

The specification relates generally to loading coefficients of a coefficient matrix into memory cells, and more particularly to loading coefficients of a coefficient matrix into memory cells in a diagonalized pattern.

### BACKGROUND

Computing devices with spatial architecture may be employed for highly efficient parallel processing operations. To optimize the parallel processing operations, data should be loaded into memory in an optimal pattern for the subsequent processing. However, the memory loading may itself be time-consuming and complex to load in the optimal pattern.

### SUMMARY

According to an aspect of the present specification an example device includes: a plurality of processing elements configured to perform a processing operation; memory cells interconnected with the processing elements, the memory cells organized into a plurality of wordlines, each wordline containing a set of columns; a controller interconnected with the processing elements, the controller configured to: for each coefficient vector of a coefficient matrix for the processing operation: assign a wordline identifier to each processing element; assign a column identifier to each processing element; write coefficients from the coefficient vector to the corresponding memory cell defined by the wordline identifier and the column identifier for each processing element; wherein the wordline identifiers and the column identifiers are assigned to the processing elements to load the coefficients of the coefficient vector in a diagonalized pattern in the memory cells.

According to another aspect of the present specification, an example method includes: for each coefficient vector of a coefficient matrix for a processing operation: assigning a wordline identifier to each processing element of a plurality of processing elements; assigning a column identifier to each processing element; writing coefficients from the coefficient vector to a corresponding memory cell defined by the wordline identifier and the column identifier for each processing element; wherein the wordline identifiers and the column identifiers are assigned to the processing elements to load the coefficients in a diagonalized pattern in the memory cells.

### BRIEF DESCRIPTION OF DRAWINGS

Implementations are described with reference to the following figures, in which:

FIG. 1 depicts a schematic block diagram of an example computing device configured for diagonally loading coefficient matrices into memory.

FIG. 2 depicts a schematic block diagram of a plurality of processing elements of the computing device of FIG. 1.

FIGS. 3A and 3B depict schematic diagrams of matrix-vector multiplication and diagonalized storage of coefficients in the matrix.

FIG. 4 depicts a flowchart of an example method of diagonally loading coefficient matrices into memory.

FIG. 5A and 5B depict a schematic diagram of diagonally loading a first coefficient vector and corresponding wordline and column identifiers assigned to each processing element.

FIG. 6A and 6B depict a schematic diagram of diagonally loading a subsequent coefficient vector and corresponding wordline and column identifiers assigned to each processing element.

FIG. 7 depicts a schematic diagram of wordline identifier patterns and column identifier patterns stored at the processing elements.

### DETAILED DESCRIPTION

Processing operations in spatial architecture computing devices may be represented as matrix-vector multiplications, or a dot product of each matrix row with the vector. This process may be parallelized to independent processing elements, according to the size of the matrix. Each processing element may perform a multiply-and-accumulate operation. In particular, each processing element may be configured to select data from the same address in memory incrementally based on broadcasting of the inputs. However, broadcasting is expensive.

In accordance with the presently described architecture, the inputs may be rotated to increment the memory address, thereby reducing the number of broadcast operations required. With rotating inputs, the coefficients stored in memory should be stored in a diagonalized pattern (i.e., with each vector of the matrix following a diagonal pattern) to enable the appropriate multiply-and-accumulate to achieve the dot products. Accordingly, in response to identifying a coefficient matrix to load, the presently described computing device is configured to employ wordline and column identifiers to select particular memory cells in which to write the respective coefficients of a vector. In particular, the wordline and column identifiers may follow a recurring pattern stored at each processing element to select the appropriate identifier, and further reduce individual broadcasting of memory addresses.

The computing device 100 includes a plurality of banks 102 of processing elements. The banks 102 may be operated in a cooperative manner to implement a parallel processing scheme, such as a SIMD (single instruction/multiple data) scheme. For example, at a low level, the computing device 100 operates according to SIMD principles, within a bank, row, or other grouping of processing elements, where such groupings may be referred to as compute units. A compute unit may be configured to perform a particular processing objective, and such arrangements may provide for flexibility in how a particular operation is performed. At a high level, compute units communicate via a dataflow spatial architecture that is akin to a mesh network. The computing device 100 may be deployed to implement operations for a neural network computation, artificial intelligence (AI) program, large-language models (LLMs), machine vision programs, or similar.

The banks 102 may be arranged in a regular rectangular grid-like pattern, as illustrated. For sake of explanation, relative directions mentioned herein will be referred to as up, down, vertical, left, right, horizontal, and so on. However, it is understood that such directions are approximations, are not based on any particular reference direction, and are not to be considered limiting. Any practical number of banks 102 may be used. Limitations in semiconductor fabrication techniques may govern. In some examples, 512 banks 102 are arranged in a 32-by-16 grid.

A bank 102 may include an array of processing elements or PEs, as will be described further herein. The bank 102 itself may be a computing device, which may be termed a SIMD or at-memory computing device. US Patent No. 11,881,872, which is incorporated herein by reference, may be referenced for additional details concerning processing elements and banks thereof. More generally, the computing device 100 includes a plurality of processing elements, in which subsets of the processing elements may be configured to operate in SIMD fashion. The device 100 may include hundreds, thousands, or more processing elements.

Instructions and/or data may be communicated to/from the banks 102 via an input/output (I/O) bus or buses, which may be implemented in one or more segments. The I/O bus(es) may allow communication among banks 102 in a vertical direction, in a horizontal direction, and may be restricted to immediately adjacent banks 102 or may extend to further banks 102 in either the vertical or horizontal directions.

The computing device 100 may include a main processor (not shown) to communicate instructions and/or data with the banks 102 via the I/O buses, manage operations of the banks 102, and/or provide an I/O interface for a user, network, or other device. The I/O buses may include a Peripheral Component Interconnect Express (PCIe) interface or similar.

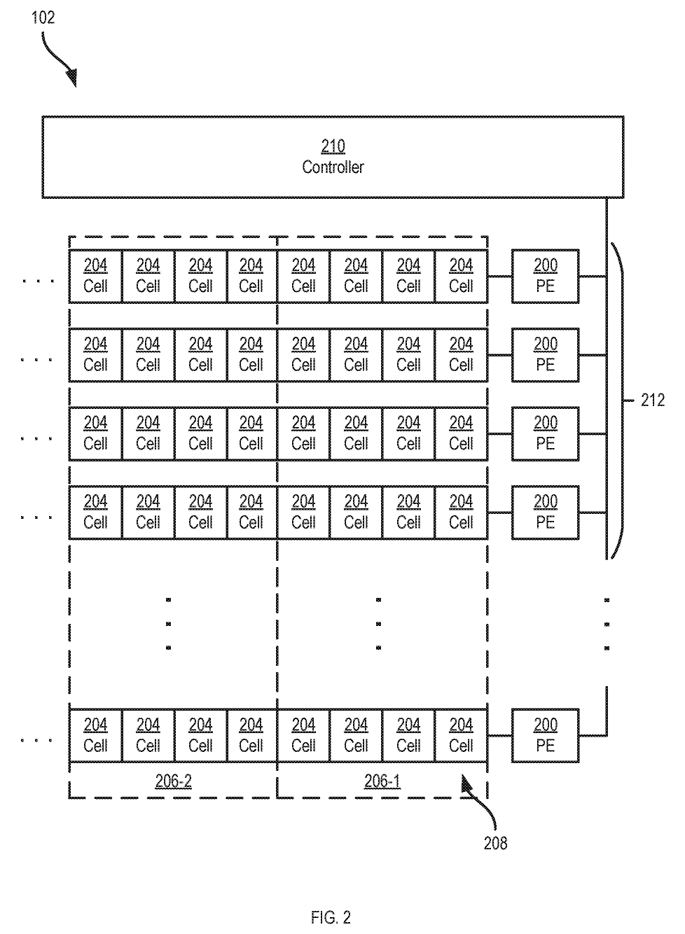

Referring now to FIG. 2, one of the banks 102 is depicted in greater detail. In particular, each bank 102 includes an array of processing elements or PEs 200. Processing elements 200 may be logically and, optionally, physically arranged in a two-dimensional array. Such an array may be considered to have rows and columns.

Each processing element 200 includes operational circuitry to perform operations, such as multiplying accumulations. For example, each processing element 200 may include a multiplying accumulator and supporting circuitry. The processing element 200 may additionally or alternatively include an arithmetic logic unit (ALU) or similar processing or logic circuity to perform desired operations.

Each processing element 200 includes or is connected to working memory (e.g., random-access memory or RAM) dedicated to that processing element 200. In aggregate, the working memory may form an array 202 of memory cells 204. To facilitate memory addressing, the memory cells 204 may be organized into wordlines, of which two wordlines 206-1 and 206-2 (referred to herein generically as a wordline and collectively as the wordlines 206). Each wordline 206 may, in turn, include a predefined number of columns 208 of memory cells 204. In the presently illustrated example, each wordline 206 includes four columns 208. Accordingly, within the working memory dedicated to a given processing element 200, each memory cell 204 may have a distinct memory address given by a wordline identifier identifying the wordline 206 and a column identifier identifying the column 208 within the given wordline 206. Furthermore, the wordlines 206 and columns 208 may be extended across the working memory of each of the PEs 200 in the bank 102 (or in the row of the bank 102, as applicable). Accordingly, in accordance with SIMD operating principles, the PEs 200 may write to the same address (i.e., given by wordline identifier and column identifier) within the respective working memory for each PE 200. Data stored in memory cells 204 may be any suitable data, such as operands, operators, coefficients, vector components, and similar.

A processing element 200 may be connected with one or more neighboring processing elements 200 to share data and instructions. Processing element interconnections may be provided in the row direction, the column direction, or both.

The computing device 100 further includes a controller 210 connected to the processing elements 200 of each bank 102. A controller 210 is a processor (e.g., microcontroller, etc.) that may be configured with instructions to control the connected processing elements 200. The controller 210 is dedicated to the processing elements 200 of the bank 102 it serves. The controller 210 may be considered part of the bank 102 or may be considered external to the bank 102.

The controller 210 controls the connected processing elements 200 to perform the same operation on different data contained in each processing element 200. The controller 210 may further control the loading/retrieving of data to/from the processing elements 200, control the communication among processing elements 200, and/or control other functions for the processing elements 200. Any suitable number of controllers 210 may be provided to control the processing elements 200. Controllers 210 may be connected to each other for mutual communications. Controllers 210 may be arranged in a hierarchy, in which, for example, a main controller controls sub-controllers, which in turn control subsets of processing elements 200.

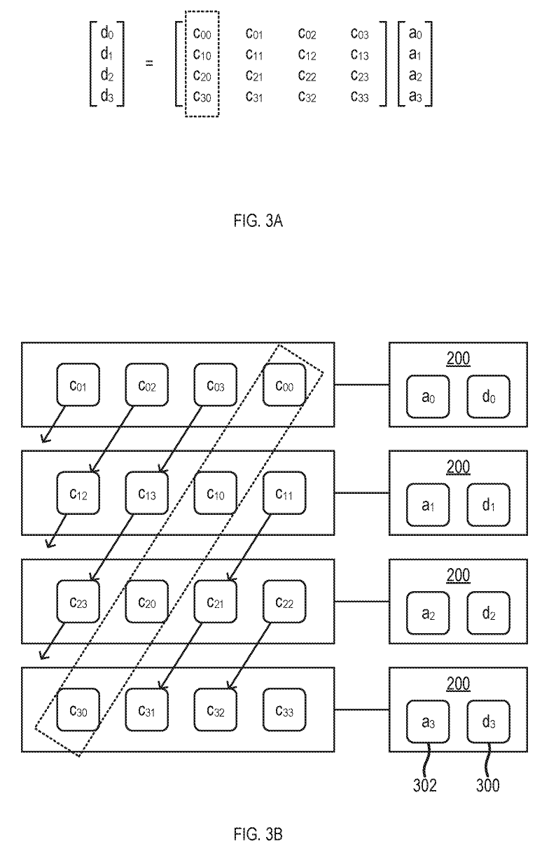

FIG. 3A shows an example matrix multiplication to be processed by the PEs 108. A matrix multiplication may be a generalized matrix-vector multiply (GEMV). A matrix multiplication may use a coefficient matrix M and an input vector A to obtain a resultant vector D. In this example, the coefficient matrix M is a four-by-four matrix and the vectors A and D are of length four. In other examples, matrices and vectors of any practical size may be used. In other examples, a matrix multiplication may be a generalized matrix-matrix multiply (GEMM).

FIG. 3B illustrates an array of PEs 200 and related memory cells 204 for carrying out the matrix multiplication illustrated in FIG. 3A. Each PE 200 may include local registers 300, 302 to hold data undergoing an operation. The memory cells 204 may also hold data contributing to the operation.

As matrix multiplication involves sums of products, the PEs 200 may additively accumulate resultant vector components d₀to d₃ in respective registers 300, while input vector components a₀ to a₃ are multiplied by respective coefficients c₀₀to c₃₃. That is, one PE 200 may accumulate a resultant vector component d₀, a neighbor PE 200 may accumulate another resultant vector component d₁, and so on. Resultant vector components d₀ to d₃ may be considered dot products. Generally, a GEMV may be considered a collection of dot products of a vector with a set of vectors represented by the rows of a matrix.

To facilitate matrix multiplication, the contents of registers 300 and/or registers 302 may be rearranged among the PEs 108. In this example, resultant vector components d₀ to d₃ remain fixed and input vector components a₀ to a₃ are moved.

Therefore, to enable the appropriate multiplication of the input vector components aₓ with the coefficients c_{xy}, the coefficients c₀₀ to c₃₃ may be loaded into memory cells in a diagonalized manner to optimize access operations to the memory cells 204 during the GEMV operation.

In the example illustrated in FIGS. 3A and 3B, the input vector components a₀ to a₃are loaded into a sequence of PEs 108 that are to accumulate resultant vector components d₀ to d₃ in the same sequence. The relevant coefficients c₀₀, c₁₁, c₂₂, c₃₃ are accessed and multiplied by the respective input vector components a₀ to a₃. That is, a₀and c₀₀ are multiplied and then accumulated as d₀, a₁ and c₁₁ are multiplied and then accumulated as d₁, and so on.

The input vector components a₀ to a₃ are then rearranged so that a remaining contribution of each input vector components a₀ to a₃ to a respective resultant vector components d₀ to d₃ may be accumulated.

For example, input vector components a₀ to a₂ are moved one PE 108 to the right and input vector components a₃ is moved three PEs 108 to the left. The result is that a next arrangement of input vector components a₃, a₀, a₁, a₂ at the PEs 108 is achieved, where each input vector component is located at a PE 108 that it has not yet occupied during the present matrix multiplication. Appropriate coefficients c₀₃, c₁₀, c₂₁, c₃₂ in memory cells 204 are then accessed and multiplied by the respective input vector components a₃, a₀, a₁, a₂. That is, a₃ and c₀₃ are multiplied and then accumulated as d₀, a₀ and c₁₀ are multiplied and then accumulated as d₁, and so on.

The input vector components a₀ to a₃ are then rearranged twice more, with multiplying accumulation being performed with the input vector components and appropriate coefficients at each new arrangement. At the conclusion of four sets of multiplying accumulation and three intervening rearrangements, the accumulated resultant vector components d₀ to d₃ represent the final result of the matrix multiplication.

Thus, the arrangements of coefficients c₀₀ to c₃₃ in the memory cells 204 may be predetermined, so that each PE 108 may access the next coefficient needed without requiring coefficients to be moved among memory cells 204. Therefore, the coefficients c₀₀ to c₃₃ may be arranged in the memory cells 204 in a diagonalized manner, such that a first column of coefficients, as loaded into the memory cells 204, is used for a first arrangement of input vector components aₓ, a second column of coefficients is used for a second arrangement of input vector components aₓ, and so on.

In particular, as can be seen, a coefficient vector V corresponding to the first column of coefficients from the matrix M is loaded into the memory cells 204 in a diagonalized manner. Similarly, each other column (i.e., as represented by further coefficient vectors) in the matrix M has its coefficients loaded into the memory cells 204 in a diagonalized pattern.

Hence, the respective memory addresses referenced by the PEs 108 after a rearrangement of input vector components may be incremented or decremented identically. For example, with a first arrangement of input vector components, each PE 108 may reference its respective memory cell at address 0 for the appropriate coefficient. Likewise, with a second arrangement of input vector components, each PE 108 may reference its respective memory cell at address 1 for the appropriate coefficient, and so on. In particular, each row of memory cells 204 is addressed by the same wordline identifier and column identifier combination, and hence the controller may issue instructions to access a given combination of wordline identifier and column identifier to multiply the input vector component aₓ by the coefficient c_{xy} stored at the given memory cell address, thereby increasing the efficiency of the GEMV operation.

In this respect, it is advantageous for the coefficients from the coefficient matrix M of a processing operation to be loaded into the memory cells 204 in a diagonalized manner. However, the coefficients are generally selected from the coefficient matrix M as a coefficient vector V, corresponding to a row or a column of the coefficient matrix M. Accordingly, to load a coefficient vector into the memory cells 204 in a diagonalized pattern, the controller 210 may identify a wordline identifier and column identifier combination for each PE 200 to store its respective coefficient.

In particular, in accordance with the present disclosure, the controller 210 may be configured to send a wordline or set of wordlines to a subset of PEs 200. In particular, returning to FIG. 2, the PEs 200 may be organized into pods 212 having a predefined size (i.e., number of PEs 200). For example, the size of the pods 212 may be equal to the size (i.e., number of columns) of each wordline 206. In other examples, the size of the pods 212 and the wordlines 206 may be independent of one another.

The controller 210 may therefore send a set of wordline identifiers to each pod 212. For example, based on the size of the pods 212 and the wordlines 206, four coefficients for a given pod 212 will span at most two wordlines 206. Accordingly, the set of wordline identifiers sent to each pod 212 may include at most two wordline identifiers. The controller 210 may additionally send a column identifier to each PE 200 in the pod, or the PE 200 may be configured to determine the column identifier value based on patterns stored at the PE, as will be described further herein. Accordingly, each PE 200 in the pod 212 may have a different combination of wordline identifier and column identifier, thereby allowing the PEs 200 in the pod to load the coefficients from a coefficient vector into memory cells 204 at different addresses, namely, in a diagonalized pattern.

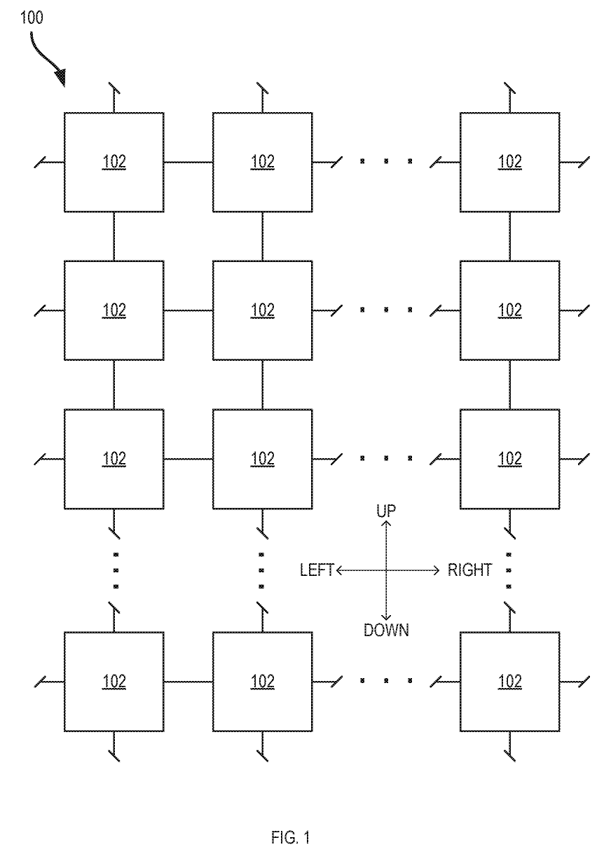

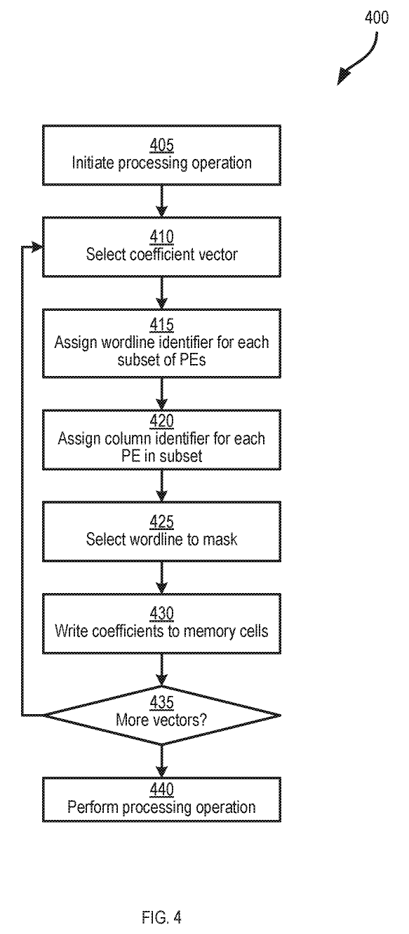

Turning now to FIG. 4, the functionality implemented by the device 100 will be discussed in greater detail. FIG. 4 illustrates a method 400 of diagonally loading coefficients for a processing operation. The method 400 will be discussed in conjunction with its performance by the device 100, with reference to the components described in FIGS. 1 to 3. In other examples, the method 400 may be performed by other suitable devices or systems.

At block 405, a processing operation is initiated at the device 100. For example, the processing operation may be a GEMV. The device 100, and in particular, the controller 210 may identify a coefficient matrix to be applied in the processing operation. In some examples, the processing operation may be newly initiated, while in other examples, the processing operation may be triggered from another processing operation, for example executed at a different bank 102 or other suitable compute unit. That is, the processing operation and the coefficient matrix for the processing operation may include the results of a related prior processing operation.

At block 410, the controller 210 is configured to select a coefficient vector from the coefficient matrix to load into the memory cells 204. In particular, the coefficient matrix may be defined as a series of coefficient vectors, and the controller 210 may select one coefficient vector from the series. Preferably, the controller 210 may select the coefficient vector according to a predefined, regular sequence within the series (e.g., beginning at one edge of the matrix and proceeding through to the opposing edge of the matrix) to leverage predefined patterns, as will be described further herein.

At block 415, the controller 210 is configured to assign a set of wordline identifiers to each subset or pod 212 of PEs 200 for the coefficient vector selected at block 410. In particular, in the present example, since the pods 212 and the wordlines 206 are each of size 4, the coefficients may span at most two wordlines. Accordingly, the controller 210 may send a set of at most two wordline identifiers to each pod 212 of PEs 200. Further, for some coefficient vectors of the coefficient matrix, the coefficients for a given pod may all be stored within the same wordline. Accordingly, for such vectors, the set may include a single wordline identifier for the pod 212.

In particular, the controller 210 may preferably send the set of wordline identifiers to each subset or pod 212 of PEs 200, rather than to each individual PE 200. In such examples, each PE 200 may be configured to select, from the wordline identifiers, one wordline 206 to which to write. For example, each PE 200 may select the wordline identifier to write to based on a predefined wordline identifier pattern stored at the PE 200. The appropriate element within the pattern may be selected according to the sequence of the coefficient vector within the series of vectors forming the coefficient matrix. For example, the pattern may be instantiated with the selection of the first coefficient vector (e.g., left-most, right-most, top-most, bottom-most, or otherwise predefined initial vector) in the coefficient matrix, and the pattern may be looped through sequentially upon the selection of each subsequent vector. In other examples, the pattern may be instantiated based on the wordline identifiers themselves, such as when only one wordline identifier is included in the set of wordline identifiers. Still further manners of instantiating and/or determining the appropriate element from the pattern to be applied are also contemplated.

At block 420, a column identifier may similarly be assigned to each PE 200 in the pod. In some examples, the column identifier may be specifically assigned by the controller 210, while in other examples, the PE 200 may determine the column identifier, for example based on the set of wordline identifiers sent to the pod 212. For example, each PE 200 may additionally store a column identifier pattern, allowing the PE 200 to identify which column to write to.

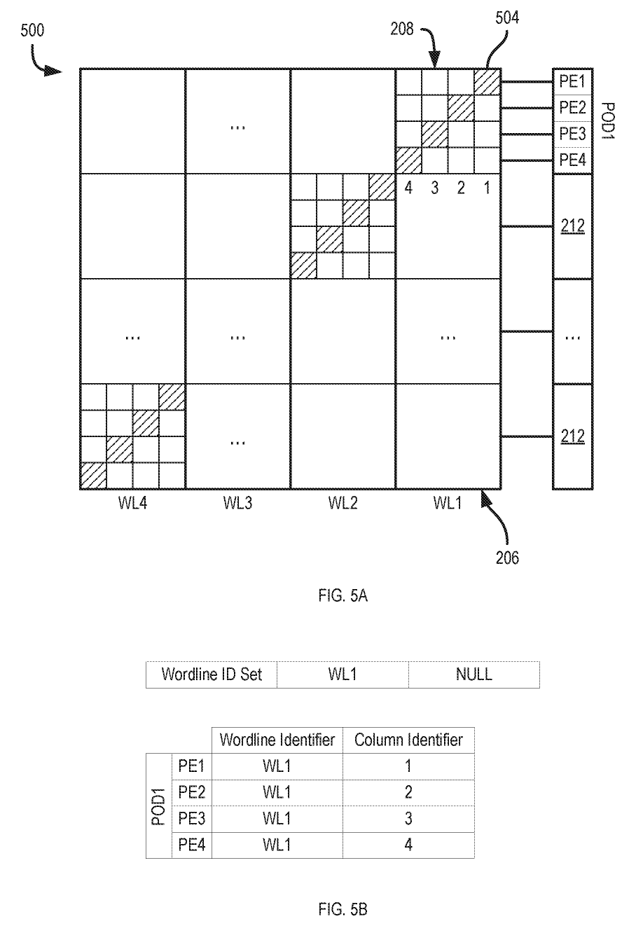

For example, referring to FIG. 5A, a schematic diagram of a row of PEs 200 and associated the associate working memory 500 is depicted. The PEs 200 are organized into the pods 212, and the working memory 500 is organized into the wordlines 206, with each wordline 206 having columns 208.

At a first iteration of blocks 410 through 420, the controller 210 may be configured to select an initial coefficient vector. The initial coefficient vector may be loaded into target memory cells 504 (illustrated as being hatched) in the working memory 500. As will be apparent, since the pods 212 and the wordlines 206 are the same size, each pod 212 may be assigned one wordline in which the coefficients are to be written. Accordingly, each pod 212 may receive one wordline identifier at block 415. Further, the wordline identifiers assigned to each pod 212 may be unique.

Within each pod 212, each PE 200 is configured with a different column identifier value to enable the diagonalized pattern within the wordline 206. For example, referring to FIG. 5B, the POD1 including PEs identified as PE1, PE2, PE3, and PE4 may receive, from the controller 210, a set of wordline identifiers of WL1 and NULL (i.e., indicating that only one wordline is to be targeted in the present write operation). The wordline identifiers and column identifiers may then be assigned to the PEs in POD1, such that PE1 is assigned to wordline identifier WL1 and column identifier 1, PE2 is assigned to wordline identifier WL1 and column identifier 2, PE3 is assigned to wordline identifier WL1 and column identifier 3, and PE4 is assigned to wordline identifier WL1 and column identifier 4.

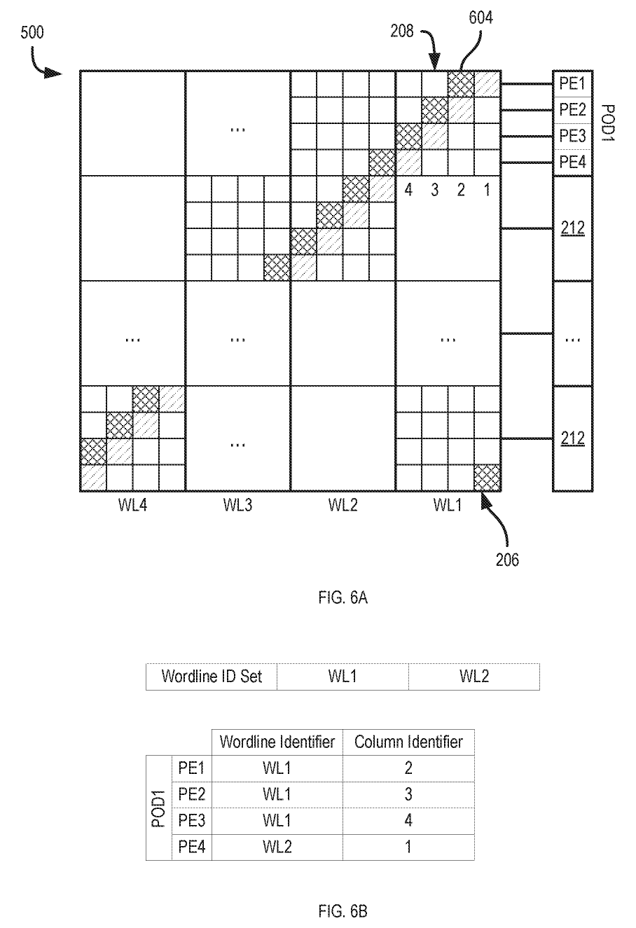

Referring to FIG. 6A, a schematic diagram of the working memory 500 is depicted at a second iteration of blocks 410 through 420. In particular, the controller 210 may be configured to select a subsequent coefficient vector. Preferably, the subsequent coefficient vector may be sequential to the previously selected coefficient vector. The subsequent coefficient vector may be loaded into target memory cells 604, illustrated as being cross-hatched, in the working memory 500. In particular, since the target memory cells 604 are shifted, the target memory cells 604 for each pod 212 may span more than one wordline 206.

Accordingly, referring to FIG. 6B, the POD1 including PEs identified as PE1, PE2, PE3, and PE4 may receive, from the controller 210, a set of wordline identifiers of WL1 and WL2. To achieve the diagonalized pattern, the wordline identifiers may then be assigned to the PEs in POD1 such that PE1 is assigned to wordline identifier WL1 and column identifier 2, PE2 is assigned to wordline identifier WL1 and column identifier 3, PE3 is assigned to wordline identifier WL1 and column identifier 4, and WL4 is assigned to wordline identifier WL2 and column identifier 1.

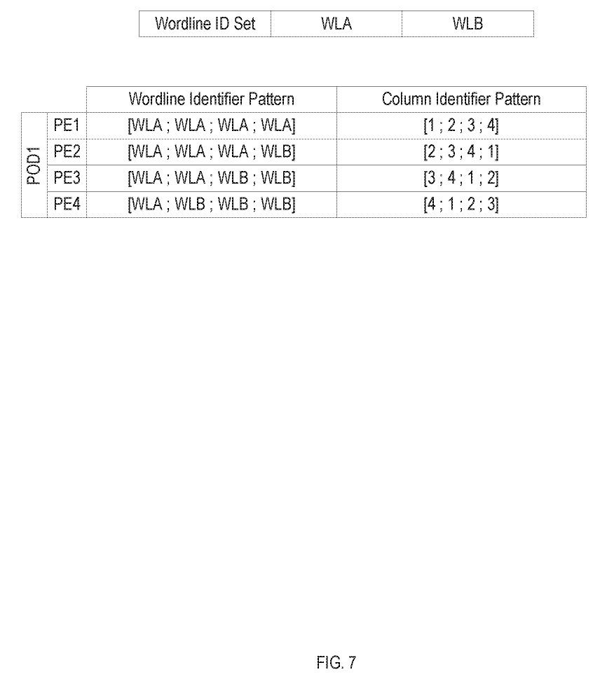

Similarly, subsequent iterations of blocks 410 through 420 may generate different assignments of wordline identifier and column identifier combinations. When the coefficient vectors are selected in an ordered sequence, the wordline identifiers and column identifiers at each iteration may follow a predictable sequence. Accordingly, each processing element 200 in a pod 212 may store a wordline identifier pattern and a column identifier pattern, allowing the PE 200 to select the appropriate wordline identifier and column identifier based on the set of wordline identifiers received. For example, FIG. 7 illustrates example wordline identifier and column identifier patterns for each of the PEs in POD1.

The pattern may be instantiated at an initial selection of a coefficient vector and looped through once complete. In other examples, the pattern may be instantiated when, for example, only one wordline identifier is received in the set. This may allow coefficients to be written in smaller subsets, and may allow for interruptions or revisions. In still further examples, the pattern may be selected according to the sequence number of the coefficient vector within the series of vectors (e.g., the sequence number modulo four, or another suitable size of the pod and/or wordline as appropriate).

Further, in examples where two or more wordlines are identified, each processing element 200 may have more than one wordline option in which to write, while only writing in one. In some examples, rather than selecting a single wordline in which to write, the processing element 200 may apply a mask non-target wordlines. Accordingly, returning to FIG. 4, at block 425, each processing element 200 may optionally select one or more wordlines to mask. For example, the identifiers of the selected wordlines to mask may be written to a mask register at the PE 200. In some examples, the selected wordline(s) to mask may be selected dynamically, as an inverse to the target wordline assigned at block 415. In other examples, the wordlines to mask may similarly be selected according to a masking pattern stored at the PE 200, and according to the sequence of the coefficient vector selected at block 410.

At block 430, each of the PEs 200 is configured to write the respective coefficient from the coefficient vector selected at block 410 to the designated target memory cell, according to the wordline and column identifiers assigned at blocks 415 and 420, respectively. In particular, since the wordline and column identifiers are assigned to select a diagonalized pattern of memory cells, the coefficients from the coefficient vector may be written into the memory cells in a corresponding diagonalized pattern.

At block 435, the controller 210 is configured to determine whether there are additional coefficient vectors in the series of coefficient vectors forming the coefficient matrix to be loaded into the memory cells 204.

If the determination at block 435 is affirmative, that is, there are more coefficient vectors to be loaded into the memory cells 204, then the controller 210 returns to block 410 to select a subsequent coefficient vector. Preferably, the subsequent coefficient vector selected at each subsequent iteration of block 410 may be predefined according to the sequence of the coefficient vectors within the series.

If the determination at block 435 is negative, that is, there are no more coefficient vectors to be loaded into the memory cells 204, then the controller 210 proceeds to block 440. In particular, if there are no more coefficient vectors to be loaded, then the controller 210 determines that the entire coefficient matrix for the processing operation has been loaded into the memory cells, and hence the controller 210 may determine that the processing operation may proceed. Accordingly, at block 440, the controller 210 may control the processing elements 200 to proceed with the processing operation. That is, the controller 210 may provide processing instructions to the processing elements 200, for example preferably in a SIMD manner, to apply the processing operation, employing the coefficients loaded into the memory cells 204. In particular, the controller 210 may control the processing elements 200 to rotate inputs in accordance with the GEMV operation as described above to leverage the diagonalized pattern of the coefficients and increase the efficiency of the processing operation.

As described herein, the computing device leverage the structure of PE pods, and the wordline and column architecture of working memory to enable diagonalized loading of the memory cells. In particular, wordlines may be broadcast to each pod of PEs. Each PE may store wordline identifier patterns and/or masking patterns and column identifier patterns to be applied to the broadcast wordlines to determine the appropriate memory cell address to which to write to achieve the diagonalized pattern. In other examples, the column identifier may additionally be broadcast to the PEs by the controller. The diagonalized loading pattern may be used to diagonalize coefficient matrices during loading, as well as to diagonalize transposed coefficient matrices.

The scope of the claims should not be limited by the embodiments set forth in the above examples but should be given the broadest interpretation consistent with the description as a whole.

1. A device comprising:
a plurality of processing elements configured to perform a processing operation;
memory cells interconnected with the processing elements, the memory cells organized into a plurality of wordlines, each wordline containing a set of columns;
a controller interconnected with the processing elements, the controller configured to:
for each coefficient vector of a coefficient matrix for the processing operation:
assign a wordline identifier to each processing element;
assign a column identifier to each processing element; and
write coefficients from the coefficient vector to the corresponding memory cell defined by the wordline identifier and the column identifier for each processing element; and
wherein the wordline identifiers and the column identifiers are assigned to the processing elements to load the coefficients of the coefficient vector in a diagonalized pattern in the memory cells.

2. The device of claim 1, wherein the plurality of processing elements are organized into pods, each pod including a predefined number of the processing elements.

3. The device of claim 2, wherein, to assign the wordline identifier to each processing element:
the controller is configured to send a set of wordline identifiers to each pod; and
each processing element in the pod is configured to select the wordline identifier from the set based on a wordline identifier pattern stored at the processing element.

4. The device of claim 3, wherein the processing element is further configured to apply a mask to a remainder of the wordline identifiers in the set.

5. The device of claim 3, wherein the processing element is configured to select the wordline identifier based on a sequence of the coefficient vector within a series of coefficient vectors defining the coefficient matrix.

6. The device of claim 1, wherein to assign the column identifier, each processing element is configured to select the column identifier based on a column identifier pattern stored at the processing element.

7. The device of claim 6, wherein the processing element is configured to select the column identifier based on a sequence of the coefficient vector within a series of coefficient vectors defining the coefficient matrix.

8. A method comprising:
for each coefficient vector of a coefficient matrix for a processing operation:
assigning a wordline identifier to each processing element of a plurality of processing elements;
assigning a column identifier to each processing element; and
writing coefficients from the coefficient vector to a corresponding memory cell defined by the wordline identifier and the column identifier for each processing element; and
wherein the wordline identifiers and the column identifiers are assigned to the processing elements to load the coefficients in a diagonalized pattern in the memory cells.

9. The method of claim 8, wherein assigning the wordline identifier to each processing element comprises:
receiving, at each pod having a predefined number of processing elements, a respective set of wordline identifiers; and
selecting, by each processing element in the pod, the wordline identifier from the set based on a wordline identifier pattern stored at the processing element.

10. The method of claim 9, further comprising applying, by each processing element, a mask to a remainder of the wordline identifiers in the set.

11. The method of claim 9, comprising selecting, by each processing element, the wordline identifier based on a sequence of the coefficient vector in a series of coefficient vectors forming the coefficient matrix.

12. The method of claim 8, wherein assigning the column identifier comprises selecting, by each processing element, the column identifier based on a column identifier pattern stored at the processing element.

13. The method of claim 12, comprising selecting, by each processing element, the column identifier based on a sequence of the coefficient vector in a series of coefficient vectors forming the coefficient matrix.

14. The method of claim 8, further comprising, in response to loading all of the coefficient vectors of the coefficient matrix, proceeding with the processing operation.
